(19) United States
(12) Patent Application Publication
(10) Pub. No.: US 2023/0063785 A1
(43) Pub. Date: Mar. 2, 2023

(54) MATERIAL TREATMENT APPARATUS AND PROCESS USING HYDROGEN

(71) Applicant: Rio Tinto Alcan International Limited, Montréal (CA)

(72) Inventor: Tomas Mach, Montréal (CA)

(21) Appl. No.: 17/792,610

(22) PCT Filed: Jan. 13, 2021
(86) PCT No.: PCT/IB2021/050199

§ 371 Date: Jul. 13, 2022

(30) Foreign Application Priority Data
Jan. 13, 2020 (AU) 2020900091
Mar. 13, 2020 (AU) 2020900768

(51) Int. Cl. B01J 6/00; C22B 5/12; C21B 13/00

(52) U.S. Cl. CPC B01J 6/001; C22B 5/12; C21B 13/0073

(57) ABSTRACT

A process for treating a material, such as by calcination or reduction processes, is disclosed. The process comprises reacting hydrogen and oxygen in a reaction chamber and producing heat and steam, discharging steam from the reaction chamber, using the heat to treat the material and produce a treated material, and returning at least some of the steam discharged from the reaction chamber to the process. An apparatus is also disclosed.

### TECHNICAL FIELD

The present invention relates to a process and an apparatus for treating a material through calcination.

The present invention also relates to a process and an apparatus for treating a material through reductive processes.

### BACKGROUND ART

Calcination (Dehydration) Processes

Materials are often treated to remove water, such as from hydrates, and/or oxygen, such as from oxides.

For example, in the production of alumina (Al₂O₃) in an alumina production plant, such as a Bayer process plant, aluminium hydroxide (Al₂O₃.3H₂O—also termed alumina hydroxide, aluminium trihydrate and hydrated alumina) is calcined to remove water. Similarly, dehydration of gypsum (CaSO₄.2H₂O) forms anhydrite (CaSO₄).

A known calciner has a reaction chamber that combusts natural gas and oxygen to form heat and flue gas that comprises N₂, CO₂ and steam. The heat generated in the reaction chamber by combustion of natural gas and oxygen is used to calcine, i.e. dehydrate, hydrated materials and form dehydrated materials. Due to thermal losses during calcination the amount of energy provided to the reaction chamber is significantly more than theoretical requirements. Part of the heat generated in the reaction chamber is transferred to the steam in the flue gas. However, trying to recapture the heat in the flue gas as a way to reduce the amount of energy required for calcination can be technically difficult and/or cost prohibitive.

Reductive Processes

Metal oxides, such as hematite (Fe₂O₃), can be subjected to reducing conditions, such as in a smelting or other reduction process, to reduce the metal of the metal oxide. If sufficient reduction takes place a base metal can be formed.

Smelters and other reduction apparatus often use coal as a reducing agent to form a base metal and by-products including CO₂. However, similar to calciners, part of the heat generated during the smelting process is transferred to flue gas.

The use of natural gas for calciners and coal for smelting generates CO₂ and potentially other deleterious by-products.

The above description is not to be taken as an admission of the common general knowledge in Australia or elsewhere.

### SUMMARY OF THE INVENTION

The present invention is based on a realization by the inventors that considerable advantages can be realized by using hydrogen as a combustion fuel in place of natural gas for calcination processes, such as calcination of aluminium hydroxide to form alumina and dehydration of gypsum to form anhydrite.

The present invention is also based on a realization by the inventors that considerable advantages can be realized by using hydrogen in place of coal for reduction processes such as smelting.

The invention provides a process for treating a material to form a treated material. The treatment may include processes such as calcination (i.e. dehydration) to form a dehydrated material or reduction to form e.g. a base metal. For example, the material may be aluminium hydroxide or gypsum and the treated material may be, respectively, alumina or anhydrite. For example, the material may be hematite (Fe₂O₃) and the treated material may be iron.

By way of example, the invention provides a process for treating a material, such as by calcination or reduction processes, that comprises: reacting hydrogen and oxygen in a reaction chamber and producing heat and steam, discharging steam from the reaction chamber, using the heat to treat the material and produce a treated material, and returning at least some of the steam discharged from the reaction chamber to the process, for example to the reaction chamber.

The term “reaction chamber” is understood herein to mean a chamber for calcination or reduction reactions.

An advantage of reacting hydrogen and oxygen is that it can eliminate the need to use hydrocarbon fuel sources, such as natural gas for calcination of materials and coal for reduction, such as smelting, of materials. This can help to reduce carbon-based emissions from calcination and reduction processes.

In addition, the process may be operated with oxygen only as a source of oxygen and thereby avoid altogether the use of air (i.e. a gas mixture having 78% nitrogen and 21% oxygen). This is an advantage in terms of reducing the gas volumes processed in a plant.

The process may operate with oxygen-enriched air and, depending on the amount of enrichment reduce the amount of nitrogen compared to operating with air.

As described above, the process comprises returning at least some of the steam discharged from the reaction chamber to the reaction chamber. This is advantageous in terms of transferring back to the process, for example to the reaction chamber heat that is retained in the steam and therefore helps to reduce the amount of energy required to treat the material. The steam may also contribute to the fluidization and/or transport of the material and/or treated material through the process, for example through the reaction chamber. The discharged steam transferred to the process may be at least 30%, typically at least 40%, by volume of the volume of the discharged steam.

As described above, the process produces steam by reacting hydrogen and oxygen.

This reaction may be via combustion of hydrogen and oxygen gas.

This reaction may also be via hydrogen reacting with chemically-bound oxygen.

The term “chemically-bound” is understood herein to mean elemental oxygen that is chemically bonded to a hetero atom, such as a metal. For example, chemically-bound oxygen may include oxygen present in iron oxide.

In addition, steam may be produced in the reaction chamber when forming the treated material, for example by dehydration of the material.

The process may include maintaining the steam at a temperature that is above a condensation temperature of steam under the operating conditions in the process.

Typically, the condensation temperature of the steam is 100° C. at atmospheric pressure.

The process may be carried out at or below atmospheric pressure.

Described in an alternative way, the process may be carried out without placing the reaction chamber under a pressure above that resulting from operating the process as described above, i.e. by supplying hydrogen and oxygen to a reaction chamber and combusting hydrogen and oxygen and generating steam and heat and using the heat to treat the material in the process.

More specifically, the process may be carried out without the reaction chamber being constructed as a pressure vessel.

The process may include using steam generated in the reaction chamber as a transport, i.e. fluidizing, gas in the process.

The material and/or the treated material may be in particulate form.

When the material and/or treated material is in particulate form, the steam generated in the reaction chamber may be used to transport particulate material and/or particulate treated material into and/or out of the reaction chamber.

The process may include using steam generated in the reaction chamber as a heat transfer medium in the process.

Another advantage of reacting hydrogen and oxygen to treat a material is an opportunity to produce steam that can be used beneficially in the process and/or in other unit operations in a plant, such as a Bayer process plant or other industrial facilities, and/or a component/equipment of an industrial facility.

For example, part of the steam generated in the reaction chamber may be transferred to a component including a mechanical vapor re-compressor, a thermal vapor re-compressor, a power generator, and/or a heat recovery unit. The power generator may include a Kalina or Organic Rankine Cycle power generator. The heat recovery unit can include recuperators, regenerators, heat exchangers thermal wheels, economizers, heat pumps, and so on. As an additional example, at least some of the steam generated in the reaction chamber may be used for processes other than calcining, such as during digestion of bauxite or the evaporation of Bayer liquor.

The hydrogen may have a purity >99%.

The flue gas may be up to 100% steam.

The material may be a hydrate and may be treated to form a treated material that is a dehydrated form of the hydrate.

The process may be a calcination process to dehydrate the material.

The material may be a metal oxide, such as hematite (Fe₂O₃).

In that event, the process may be part of a smelting direct reduction process, such as to form a base metal, such as iron.

The invention also provides a plant for carrying out the process as set forth above.

The invention also provides a process of starting up a plant for treating a material, such as by calcination or reduction processes, the plant comprising a reaction chamber in which the material is treated, the process comprising: a preheating step of heating the reaction chamber until predetermined conditions, such as steady state conditions, are achieved and then commencing supply of the material to the reaction chamber.

The predetermined conditions may be steady state conditions.

The term “steady state conditions” is understood herein to mean that the process has completed a start-up phase and is operating at or above a predetermined operating state within control parameters that indicate stable operation to plant operators. The control parameters may be any suitable control parameters selected by plant operators, including temperatures at different points in the process. One example of the control parameters is a temperature that is at or above the condensation temperature of steam.

After the process has reached steady state conditions, the process may include discharging a flue gas from the reaction chamber that is at least 85%, typically at least 90, and more typically at least 95% by volume steam.

The preheating step is not confined to combusting hydrogen and oxygen. The preheating step may include combusting any suitable fuel source, including hydrocarbon fuel, in the reaction chamber or externally of the reaction chamber and transferring heat to the reaction chamber.

By way of particular example, an external steam source, for example steam generated in an industrial plant, may be used to heat the reaction chamber in the preheating step. The reaction chamber may be heated in the preheating step by transferring at least some of the generated steam into the reaction chamber.

Changing operating conditions after steady-state conditions are reached to react hydrogen and oxygen in the reaction chamber may include providing a gas feed that increases a proportion of hydrogen over a predefined period of time.

The invention also provides a process for treating a material, such as by calcination or reduction processes, the process comprising: combusting hydrogen and oxygen and generating steam and heat, using the heat to treat the material and produce a treated material, and using the steam generated from the combustion as a transport gas in the process.

The process described in the preceding paragraph may further comprise discharging steam from the process and then transferring at least some of the discharged steam to the process.

The process described may include combusting hydrogen and oxygen and generating steam and heat in the reaction chamber and treating the material in the reaction chamber.

Alternatively, the process may include combusting hydrogen and oxygen and generating steam and heat in one reaction chamber and transferring the steam and heat to a second reaction chamber and treating the material in the second reaction chamber.

The process may be applied to an existing calcination plant or reduction, such as a smelter plant, that operates with natural gas as a fuel source and air as a source of oxygen for combustion of the fuel source.

The existing plant may be suitably modified to use hydrogen as the fuel source and oxygen, typically oxygen only, as the oxygen source for reaction, such as combustion, of the fuel source.

In addition, the existing plant may be modified such that at least some steam discharged from the reaction chamber is transferred to the reaction chamber and acts as a transport gas and, optionally as a heat transfer medium.

The invention also provides an apparatus for treating a material, the apparatus comprising:

a reaction chamber configured to treat the material,

a source of hydrogen that can react with oxygen in the reaction chamber for treating the material in the reaction chamber and producing a treated material and a flue gas including steam,

an outlet for the treated material,

an outlet for the flue gas, and

a line for supplying at least a portion of flue gas discharged via the flue gas outlet to the apparatus.

The apparatus may include a line for supplying at least a portion of flue gas discharged via the flue gas outlet to a component separate to the reaction chamber.

The apparatus may include a first reaction chamber for treating the material and for combusting hydrogen and oxygen and a second reaction chamber generating heat for use in the second reaction chamber.

The two reaction chamber option may be advantageous in situations whether the treatment process of the invention is retrofitted to an existing treatment plant.

In that event, the existing reaction chamber can continue to function as a chamber for treating the material and the second reaction chamber can be purpose-built to combust hydrogen and oxygen and be positioned proximate and operatively connected to the existing plant to supply heat to the existing reaction chamber.

The invention also provides a plant for treating a material, the plant including the above described apparatus for treating a material.

### BRIEF DESCRIPTION OF THE DRAWINGS

Embodiments of the present invention are described further with reference to the accompanying non-limiting Figures of which:

FIG. 1 illustrates an embodiment of an apparatus for treating a material in accordance with the invention;

FIG. 2 illustrates another embodiment of an apparatus for treating a material in accordance with the invention;

FIG. 3 illustrates another, although not the only other, embodiment of an apparatus for treating a material in accordance with the invention; and

FIG. 4 illustrates an embodiment of a treatment plant in accordance with the invention that is based on the embodiment of the apparatus for treating a material in accordance with the invention shown in FIG. 3; and

FIG. 5 is XRD results generated in test work on calcination of gibbsite in a steam environment in accordance with the invention.

### DESCRIPTION OF EMBODIMENTS

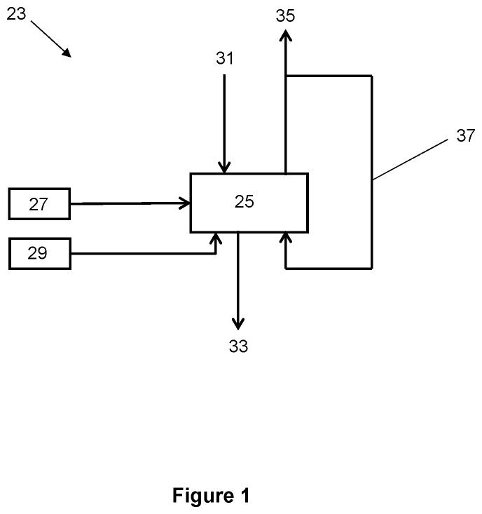

FIG. 1 shows an embodiment of an apparatus to treat a material.

In FIG. 1, the apparatus 23 includes a reaction chamber 25 for treating the material.

The reaction chamber 25 may be any suitable chamber. For example, the reaction chamber 25 can include a rotary kiln, a hydrogen reduction vessel or a gas suspension calciner chamber. The process of the invention does not have to be operated under elevated pressure conditions and, therefore, the reaction chamber 25 does not have to be a pressure vessel.

The reaction chamber 25 is in fluid communication with a hydrogen source 27, an oxygen source 29 (which in this embodiment is oxygen only), and a material source 31. The material source 31 contains a material to be treated. The reaction chamber 25 includes inlets and transfer lines for supplying these feed materials to the reaction chamber 25. The reaction chamber 25 includes a treated material discharge line 33 for discharging treated material formed in the reaction chamber 25. The reaction chamber 25 also includes an output line 35 for discharging a flue gas generated in the reaction chamber 25.

Hydrogen and oxygen from the hydrogen source 27 and the oxygen source 29 respectively are fed into and reacted, for example combusted, in the reaction chamber 25 to generate heat and the flue gas. The flue gas, including steam, is discharged from the reaction chamber 25 via the flue gas line 35.

The heat is used to treat the material.

When the material has bound-water such as a hydrate, treating the material includes driving water off the material to form the respective hydrate and steam. For example, aluminium hydroxide (Al(OH)₃), gypsum (CaSO₄.2H₂O), calcite (CaCO₃) and hydrated coal can be treated using the heat generated in the reaction chamber 25 to form, respectively, alumina (Al₂O₃), anhydrite (CaSO₄), lime (CaO) and dehydrated coal.

If the fuel source is not confined to hydrogen and includes other fuels, such as natural gas, (as may be the case in some embodiments of the invention) the flue stream will have steam plus other components such as CO₂. However, when hydrogen is the only fuel source and is reacted, for example combusted, in the reaction chamber 25 with only oxygen, steam is the only component in the flue gas line 35. It should be appreciated that the flue gas can comprise impurities such as particulate matter and other trace flue gas components but otherwise has a high purity such as >99%. The generation of only steam means that there is no need to separate out other flue gas components, such as CO₂ and N₂, before reusing the steam. Separation of flue gases into individual components is often technically difficult and cost prohibitive when looking to isolate steam from flue gas.

In one embodiment, the hydrogen source 27 has a purity >99%.

When the apparatus 23 is used to dehydrate or remove water from a material, the water driven off the material is also present in the flue gas line 35. In this way, there are two sources of steam in apparatus 23, a first source from the reaction of hydrogen and oxygen, and a second source from the dehydration of the material (i.e. hydrate).

In some embodiments the oxygen is provided in stoichiometric excess relative the hydrogen to ensure complete combustion of hydrogen.

When oxygen is provided in stoichiometric excess, the flue gas in flue gas supply 35 line may have trace amounts (e.g. <5%) of oxygen.

Generally, any excess of oxygen that is used for the combustion of hydrogen is kept to a minimum.

It is noted that if hydrogen is used to reduce a material in the form of hematite (Fe₂O₃) or another metal oxide, excess hydrogen typically is needed for the reaction, i.e. enough hydrogen to generate the temperature to allow the reaction to proceed and then enough hydrogen to allow hematite or other metal oxide to be reduced.

It is also noted that the reduction of hematite, for example, may also result in various oxidized products to various degrees, as well as iron. Hence, the product may include FeO.

As noted above, by using only hydrogen and only oxygen for reaction to generate heat for the reaction chamber 25, the apparatus 23 does not produce any CO₂ or other carbon-based emissions.

If the hydrogen is sourced from renewable sources, the apparatus 23 can significantly reduce its carbon footprint compared to apparatus that rely on hydrocarbon fuels.

In the embodiment shown in FIG. 1, the flue gas line 35 includes a flue gas transfer line 37 that is in fluid communication with the reaction chamber 25. The flue gas transfer line 37 transfers at least some of the flue gas (which typically is at least substantially steam) in the flue gas line 35 to the reaction chamber 25. When heat in flue gas is not captured and instead is vented to the environment, up to 30% of the heat generated in the reaction chamber 25 is lost to the environment. An advantage of transferring at least some of the steam back into the reaction chamber 25 via the flue gas line 35 is that heat that would otherwise be lost to the environment by venting the steam is transferred back into the reaction chamber 25. In this way, the steam can act as a heat transfer medium as heat from the steam can be used elsewhere in the apparatus 23. The use of the flue gas transfer line 37 to return steam back to the reaction chamber 25 can also help to reduce the amount of hydrogen required to maintain a reaction temperature of the reaction chamber 25 because the steam contributes heat to the reaction chamber 25.

It is noted that, in some circumstances, depending on the reaction conditions in the reaction chamber 25, there may be small amounts of solids present in the flue gas (i.e. steam) even after the flue gas has passed through a solids filtration unit, such as a bag house and/or electrostatic precipitator. If small amounts of solids are present in the flue gas additional filtration steps can be performed to remove the solids prior to transferring at least some of the steam back into the reaction chamber 25 via the flue gas transfer line 37.

To prevent condensation of steam in the flue gas line 35 and the flue gas transfer line 37, the lines 35, 37 are maintained at a temperature above a condensation temperature of the steam. In an embodiment the condensation temperature of the steam is 100° C. In an embodiment, the steam in the flue gas line 35 is superheated steam i.e. >100° C. In an embodiment, a temperature of the steam is maintained at or above 160° C. Maintaining a temperature of the steam >100° C., such as at about 160° C., can help to prevent condensation of steam. Preventing the condensation of steam can also help to reduce the occurrence of condensed steam causing the material and/or treated material to “stick” to walls and surfaces of the reaction chamber 25 and surrounding structures. Preventing steam in the flue gas line 35 from condensing helps to prevent a density of the steam from falling below a threshold value that would prevent the steam in the line 35 from acting as a fluid flow medium such as a transport gas. The latent heat required to break up steam uses a significant amount of energy, so maintaining a temperature of the apparatus 10 above the condensation temperature of steam may help to reduce or eliminate energy intense steam heating steps.

The condensation temperature of steam is dependent upon a pressure of the flue gas line 35. Generally, as a pressure of the flue gas line 35 increases, the temperature at which steam condenses also increases. As noted above, in an embodiment, the apparatus 10 is operated at atmospheric pressure, such as around 1 atm.

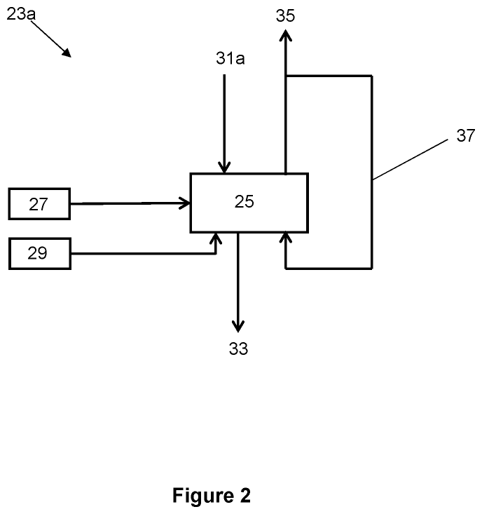

FIG. 2 shows another embodiment of an apparatus to treat a material.

Apparatus 23a in FIG. 2 is similar to apparatus 23, and the same numerical references are used to depict similar features.

A further embodiment of an apparatus is shown in FIG. 2.

Apparatus 23a in FIG. 2 is similar to apparatus 23 in FIG. 1, and the same numerical references are used to depict similar features.

As shown in FIG. 2, apparatus 23a has hydrogen source 27 and oxygen source 29 similar to apparatus 23, but material source 31a is used instead of material source 31 in FIG. 1. Accordingly, in apparatus 23a, oxygen and hydrogen are combusted in the reaction chamber 25 and generate heat and steam, but the material source 31a includes a material having chemically-bound oxygen. The hydrogen reduces the material, and the heat generated by the combustion of hydrogen and oxygen can be used to facilitate the reduction of the material. In such embodiments, combustion of hydrogen and oxygen may occur prior to introduction of material source 23a into the reaction chamber 25 to minimise or eliminate any contact of oxygen and the material. This may help to reduce or eliminate the occurrence of oxidation by oxygen of the material and/or treated material. Hydrogen would also typically be in stoichiometric excess relative oxygen from oxygen source 29 to help ensure all oxygen is consumed prior to reduction of the material.

As an example, the material source 31a can be an iron oxide such as magnetite (Fe₃O₄) and hematite (Fe₂O₃). Oxygen in the iron oxide can react with hydrogen in the reaction chamber 25 to form water and a reduced form of the iron oxide. The reduced form of iron depends on the reaction conditions and stoichiometric ratios of the metal oxide and hydrogen. For example, Fe₂O₃ can be reduced to Fe₃O₄. Further reduction can be used to form FeO and eventually Fe⁰. The degree of reduction is determined by the reaction conditions and stochiometric ratios of the reactants. Although iron oxide is described as being the material source 31a, the apparatus 23a is not limited to the reduction of iron and other metal oxides can be treated (i.e. reduced) in the apparatus 23a.

The advantages of transferring at least a portion of the flue gas (i.e. steam) from the flue gas line 35 to the reaction chamber 25 via the flue gas transfer line 37 for apparatus 23 also apply to apparatus 23a.

In the embodiments shown in FIG. 1 and FIG. 2, the flow of the material/treated material is counter-current to the flow of the flue gas. However, in some embodiments the flow of the material/treated material and flue gas is co-current. Counter-current flow may be useful when the apparatus 23 is used to dehydrate a material.

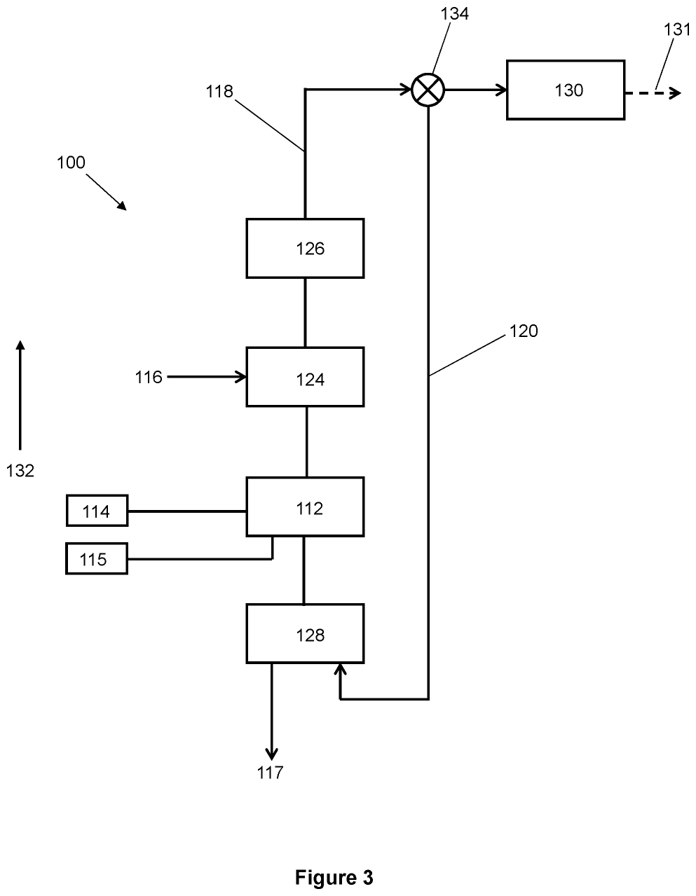

FIG. 3 shows an example of an apparatus 100 used to treat a material.

Apparatus 100 is similar to the apparatus 23 of the embodiment of FIG. 1. In this regard, the apparatus 100 includes a reaction chamber 112, a hydrogen source 114, an oxygen source 115, a material source 116, a treated material discharge line 117, a flue gas discharge line 118, and a flue gas transfer line 120 similar to the apparatus 23. However, apparatus 100 could be modified to be similar to apparatus 23a or 23b by, for example, removing oxygen source 115 and/or replacing material source 116 with material source that has chemically-bound oxygen.

In the embodiment shown in FIG. 3, material is supplied from the material source 116 to the reaction chamber 112 via a drier 124. The drier 124 removes at least some surface-bound water from the material and forms at least some dried material upstream of the reaction chamber 112. The drier 124 is typically used when the apparatus 100 is used to dehydrate a material. For example, when the material is aluminium hydroxide or gypsum, the drier 124 can remove any surface-bound water. It should be noted that the drier 124 is not required in all embodiments. After being transferred to the drier 124, if used, the material is then treated in the reaction chamber 112. For example, the reaction chamber may act as a calciner and treatment of the material is via calcination.

In the embodiment shown in FIG. 3, following e.g. calcination in the reaction chamber 112 that forms a treated material, the treated material is then transferred to a heat recovery apparatus 128 that recovers heat from the treated material. The heat recovery apparatus 128 may be any suitable form of apparatus. This heat recovery helps to cool the treated material and form cooled treated material and retain heat in the apparatus 100. Treated material discharge line 117 feeds the cooled treated material for further processing, such as packaging and shipping.

In the embodiment shown in FIG. 3, a dust recovery apparatus 126, such as a baghouse, is in fluid communication with the drier 124. Flue gas line 118 extends from the dust recovery apparatus 126.

In the embodiment shown in FIG. 3, flue gas transfer line 120 is in fluid communication with the flue gas line 118 and the heat recovery apparatus 128. At least a portion of the steam in the flue gas stream 118 is transferred to the heat recovery apparatus 128 via the flue gas transfer line 120. The steam transferred to the heat recovery apparatus 128 is used as a transport gas or fluid medium to help transfer material and/or treated material through the apparatus 100.

Steam that is passed into the heat recovery apparatus 128 travels to the reaction chamber 112, the drier 126 (if used), and then through the dust recovery apparatus 126. This direction of steam travel is shown by arrow 132. When material is introduced into the drier 124 and/or enters the reaction chamber 112, dust and other fine particulate matter is carried by the steam and transferred to the dust recovery apparatus 126.

As the material and treated material travels generally in the opposite direction to the flow of steam through the heat recovery apparatus 128, the reaction chamber 112 and the drier 126 (i.e. opposite to direction of steam travel 132), the net flow of material and treated material through the apparatus 100 is generally counter-current to the flow of steam. However, it should be noted that within the drier 124, reaction chamber 112 and heat recovery apparatus 128 there may be localised co-current flow of the material and/or treated material and the steam, but overall there can be a net counter-current flow of the material and/or treated material.

The flue gas line 118 is split into two lines. The first line is the above-described flue gas transfer line 120 that provides steam to the heat recovery apparatus 128. The second line provides steam as a steam source 130 for use externally of the apparatus 100.

The steam source 130 can be used to provide steam to other equipment/component(s) in a plant/facility such as an industrial plant/facility.

For example, if the plant is a bauxite processing plant/facility, such as a Bayer process plant, the steam source can be used by equipment/components including a digestor during digestion of bauxite, during evaporation of spent Bayer liquid, causticisation to remove impurities in the Bayer process, and in a boiler/steam generator to supplement low pressure steam. In this way, the apparatus 100 can be utilised as a steam generator. The dashed line 131 extending from steam source 130 represents the fact that in some embodiments the steam is not stored or vented but instead is used elsewhere by the equipment/component. The steam in the steam source 130 can be used in a continuous manner by the equipment/component.

In some embodiments the equipment/component is a recompressor, such as a mechanical vapor recompressor and/or a thermal vapor recompressor to “upgrade” the steam source 130 to higher pressures. For example, mechanical vapor recompression can upgrade the steam from 1 atm to 5 atm, and thermal vapor recompression can upgrade the steam from 5 atm to >10 atm.

In some embodiments the equipment/component is a power generator or power unit, such as a Kalina system, Organic Rankine Cycle system, turboexpander, and the like, that can convert heat in the steam into work, such as to produce electricity from the steam provided by the steam source 130.

In some embodiments the equipment/component is a heat recovery unit, such as a recuperator, regenerator, heat exchanger thermal wheel, economizer, heat pump, and the like, that recovers heat from the steam source 130.

It is noted that when the equipment/component recovers heat from the steam source 130, if sufficient heat is recovered from the steam source 130, the steam in the steam source 130 may condense thereby forming a water supply (not shown). The water supply may be used in the plant/facility.

To control the relative flows of steam in the flue gas transfer line 120 and the steam source 130, a control valve 134 is provided at the junction of the glue gas transfer line 120 and the steam source 130. The control valve 134 can be manually or autonomously operated to control the relative flows of steam in the flue gas transfer line 120 and the steam source 130. The relative flows of steam in the flue gas transfer line 120 and the steam source 130 may be determined by the operational conditions of the apparatus 100 and the heat requirements for e.g. calcination.

In some embodiments, the above described equipment/component is provided upstream of the control valve 134. In such embodiments, the steam in the flue gas is utilised by the equipment/component prior to passing through control valve 134 and into the flue gas transfer line 120 or the steam source 130. Steam that enters steam source 130 can be utilised elsewhere as represented by dashed line 131.

Utilising the excess steam generated by the apparatus 100 can help to improve the efficiency of other apparatus and equipment located in and around a plant/facility that requires the use of steam to operate. Utilising the excess steam can also help to convert heat energy into work.

It is noted that although the oxygen source 115 and the hydrogen source 114 are illustrated in FIG. 3 as being connected to and supplying these feed materials directly to the reaction chamber 112, the oxygen source 115 and the hydrogen source 114 only need to be in fluid communication with the reaction chamber 112. Accordingly, the oxygen source 115 and/or the hydrogen source 114 can be connected to an upstream side of the reaction chamber 112 rather than directly to the reaction chamber 112.

In FIG. 3 the upstream side of the reaction chamber 112 is opposite the direction of arrow 132 i.e. towards the heat recovery apparatus 128. For example, in an embodiment, the oxygen source 115 is connected to the heat recovery apparatus 128.

With such an arrangement, the oxygen being transferred from the oxygen source 115 to the reaction chamber 112 via the heat recovery apparatus 128 can act as a 5 cooling fluid that helps to cool treated material in or near the output line 117. At the same time, oxygen is heated prior to entering the reaction chamber 112. Similarly, the hydrogen source 114 can be connected to the heat recovery apparatus 128 instead of the oxygen source 115. As a further alternative, both the oxygen source 115 and the hydrogen source 114 are connected to the heat recovery apparatus 128.

When the oxygen source 115 and/or hydrogen source 114 are connected to an upstream side of the reaction chamber 112, the steam from the return line 120 that is transferred to the heat recovery apparatus 128 is used to transfer the oxygen and/or hydrogen gas to the reaction chamber 112 for combustion.

In an embodiment, the material being supplied to the reaction chamber 112 via material source 116 is in a form where oxygen is chemically-bound to the material, such as for material source 31a. In such an embodiment there may not be a need for oxygen source 115. Accordingly, oxygen source 115 is not required in all embodiments. However, in some embodiments, the material source 116 provides a material with chemically-bound oxygen to the reaction chamber 112 and oxygen source 115 also provides oxygen to the reaction chamber 112 in a similar way described with reference to apparatus 23a in FIG. 2.

The apparatus 23, 23a, 23b and 100 in FIGS. 1 to 3 are only illustrated in an exemplary form. These are examples of a larger number of possible embodiments. It should be appreciated that features such as the reaction chamber 112, the heat recovery apparatus 128 and the drier 126, can be formed from a number of different components and that the reaction chamber 112, the heat recovery apparatus 128 and the drier 126 may have different stages. For example, the reaction chamber 112 can have a primary and secondary reaction stage. The heat recovery apparatus 128 can also have a number of cooling stages, such as a series of interconnected cyclones that help to clarify the treated material at different stages.

The embodiment of the apparatus 100 shown in FIG. 3 can be formed as a greenfield plant or by retrofitting an existing apparatus.

As noted above, one retrofit option includes providing a separate purpose-built reaction chamber to combust hydrogen and oxygen and be positioned proximate and operatively connected to the existing apparatus to supply heat to the existing reaction chamber.

With regard to the retrofit option, existing apparatus that are used to hydrate materials, such as in calcination applications, typically vent flue gas to the atmosphere and have a natural gas supply connected to the reaction chamber. Typically, air is used as an oxygen source and as is transferred to the reaction chamber via heat recovery apparatus, for example 128. Air is also typically used as a transfer fluid. Existing calcination apparatus do not have the flue gas return line 120, the oxygen source 115 and the hydrogen source 114.

In an embodiment, the process of retrofitting an apparatus involves fitting the flue gas transfer line 120 so that a flue stream, for example 118, is in fluid communication with the reaction chamber 112. As illustrated in FIG. 3, the flue gas transfer line 120 is in fluid communication with the reaction chamber 112 via the heat recovery apparatus 128. A hydrogen source, for example 114, and optionally an oxygen source, for example 115, are then connected to the reaction chamber 112.

As the apparatus 100 shown in FIG. 3 requires the use of steam to act as a transport gas or fluid medium to help transfer material and/or treated material through the apparatus 100, the apparatus 100 should ideally be at a temperature that is at or above a condensation temperature of steam. The condensation temperature of the steam is around 100° C., although this does depend on an operational pressure of the apparatus 100. In an embodiment, the apparatus 100 is maintained at or above 160° C.

To start up the apparatus 100, the reaction chamber needs to be heated in a preheating step to be at or above a predetermined operating state as a steady-state before commencing supply of material to the reaction chamber. The predetermined operating state in an embodiment is a temperature that is at or above the condensation temperature of steam. Heating the reaction chamber 112 above the condensation temperature of steam can be achieved by combusting oxygen and hydrogen in the reaction chamber 112 to generate heat. Once sufficient heat has been generated, the reaction chamber 112 should be above the condensation temperature of steam. Steam generated by the combustion of hydrogen and oxygen can be transferred to the reaction chamber 112, for example via the flue gas return line 120, to heat the reaction chamber 112.

In an embodiment, to prevent flooding of the reaction chamber 112 with condensed steam before the reaction chamber is at or above the condensation temperature of steam, the reaction chamber 112 is typically heated in a start-up phase to a temperature above the condensation temperature of steam by preheating options other than via combustion of pure hydrogen and oxygen in the reaction chamber 112. Once the reaction chamber 112 is heated to a temperature above the condensation temperature of steam, the operation conditions can be changed, and hydrogen and oxygen can then be combusted in the reaction chamber 112 to generate heat and steam. The steam generated in the reaction chamber 112 can then be used to heat other components of the apparatus 100.

In an embodiment, at least the reaction chamber 112 is preheated in the start-up phase with an external heat source, such as steam from another location in a plant/facility prior to combustion of hydrogen and oxygen. For example, when the plant/facility is bauxite refinery, steam generated during digestion of bauxite could be transferred to the reaction chamber 112 via the steam source 130, return line 120 and heat recovery apparatus 128.

In an embodiment, preheating the reaction chamber 112 in the start-up phase involves combusting natural gas and oxygen in the reaction chamber 112 to generate heat. Once the reaction chamber 112 is at or above the condensation temperature of steam, the operation conditions are changed, and hydrogen is combusted with oxygen in place of natural gas.

The transition from natural gas to hydrogen can be a gradual transition. For example, preheating the reaction chamber 112 may first commence with 100% natural gas and over a period of time or when predefined reaction chamber conditions are met a proportion of the natural gas is replaced with hydrogen until the natural gas has been completely replaced by hydrogen. The natural gas may be completely replaced just prior to the reaction chamber 112 reaching the predetermined operating state is achieved.

Alternatively, preheating the reaction chamber 112 in the start-up phase is commenced by combusting a hydrogen-lean fuel mix that is then transitioned to a hydrogen-rich fuel mix until the predetermined operating state is achieved, at which point the hydrogen-rich fuel mix is swapped with 100% hydrogen.

In an embodiment, the reaction chamber 112 is heated to a temperature that is at or above the condensation temperature of steam by heating upstream of the reaction chamber 112, such as at a location of the heat recovery apparatus 128 and allowing the heat to transfer to the reaction chamber 112.

When the material source 116 provides a material that has chemically-bound oxygen, preheating the reaction chamber 112 can involve transferring oxygen from oxygen source 115 to the reaction chamber 112 where it is first combusted with hydrogen from hydrogen source 114 to generate heat to heat the reaction chamber 112 to a temperature that is at or above the condensation temperature of steam. The material that has chemically-bound oxygen is then transferred to the reaction chamber 112 to react with the hydrogen.

Before the material with chemically-bound oxygen is transfer to the reaction chamber 112, the supply of oxygen from oxygen source 115 can be decreased, for example down to 0%. Alternatively, the reduction in oxygen from the oxygen source 115 and transfer of the material with chemically-bound oxygen to the reaction chamber 112 can occur concurrently. As a further alternative, the material with chemically-bound oxygen can be transferred to the reaction chamber 112 prior to the reduction in the oxygen from oxygen source 115.

In embodiments where oxygen source 115 is required in addition to the material with chemically-bound oxygen from material source 116, the supply of oxygen from oxygen source 115 can be decreased down to a minimum amount of oxygen required from oxygen source depending on the treatment conditions.

For example, if the treatment conditions require that 80% of the oxygen is provided from chemically-bound oxygen and 20% of the oxygen is from the oxygen source 115, 100% of oxygen from the oxygen source 115 can first be supplied to the reaction chamber 112 to be combusted with hydrogen to generate heat, and then the amount of oxygen from oxygen source 115 can be decreased over a predetermined time or after predefined reaction conditions have been met down to 20% whilst at the same time increasing the amount of chemically-bound oxygen from the material.

Preheating the reaction chamber 112 in the start-up phase can combine different heating processes. For example, the reaction chamber 112 may be preheated using the external heat source and by combusting oxygen and hydrogen or oxygen and a fuel mix comprising natural gas.

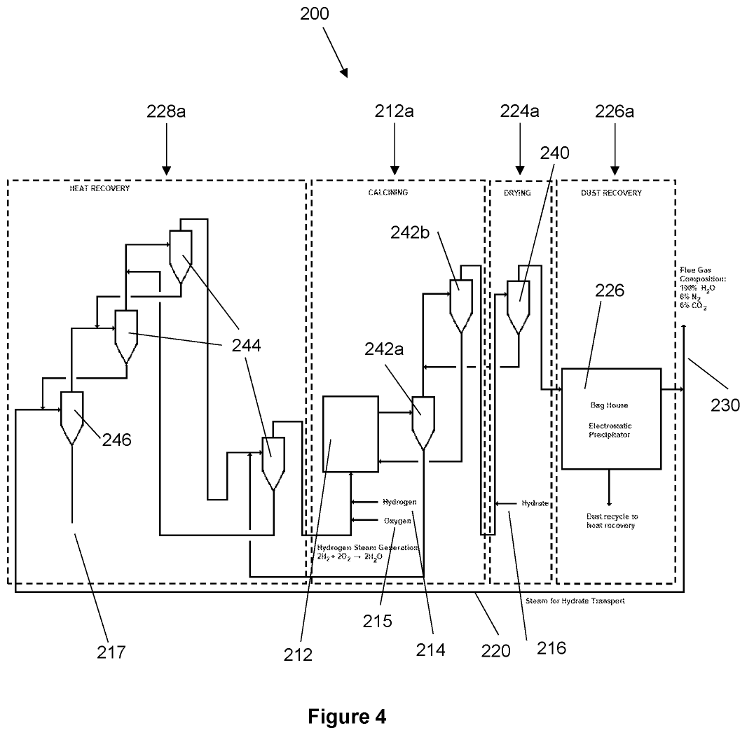

FIG. 4 shows an embodiment of a calcination plant 200, such as a calcination plant for calcination of aluminium hydroxide to form alumina, that is based on the apparatus 100 shown in FIG. 3.

The following summary outlines the relationship of the components of the apparatus 100 in FIG. 3 and the plant 200 in FIG. 4:
The reaction chamber 112 of the apparatus 100 is the calcining section 212a in plant 200.
The drier 124 of the apparatus 100 is the drying section 224a in plant 200.
The heat recovery apparatus 128 in the apparatus 100 is the heat recovery section 228a in plant 200.
The dust recovery apparatus 126 in the apparatus 100 is the dust recovery section 226a in plant 200 which is the form of a baghouse 226.
The material source 116 in the apparatus 100 is the material input 216 in plant 200.
The oxygen source 115 and the hydrogen source 114 in the apparatus 100 is, respectively, the oxygen input 215 and hydrogen input 214 in plant 200.
The return line 120 in the apparatus 100 is return steam line 220 in plant 200.
Output line 117 in the apparatus 100 is the treated material outflow 217 in plant 200.

In the plant 200 illustrated in FIG. 4 a direction of flow of steam from the treated material outflow 217 to the baghouse 230 is from left to right. Accordingly, treated material outflow 217 is upstream of the reaction chamber 212 and the baghouse 226 is downstream of the reaction chamber 212.

The drying section 224a has a cyclone 240. Material is fed into material input 216 where the above-described flow of steam through the plant 200 carries the material up to the cyclone 240. At least some and typically most of the surface-bound water is removed from the material during transport from the input 216 to cyclone 240. The cyclone 240 clarifies the material and dust and other unwanted fine particulate matter is transferred to the baghouse 226. The clarified material is then transferred from cyclone 240 to the calcining section 212a.

The calcining section 212a has cyclones 242a and 242b positioned downstream of the reaction chamber 212. Clarified material is fed from cyclone 240 in the drying section 224a to a position upstream of cyclone 242b where steam then transfers the clarified material downstream to cyclone 242b for further clarifying the material. Further clarified material (and any formed treated material as a consequence of calcination in the cyclone 242b) is then transferred to the reaction chamber 212. Hydrogen input 214 and oxygen input 215 are immediately upstream of the reaction chamber 212. Hydrogen and oxygen are fed through their respective inputs 214 and 215 into the reaction chamber 212 where they are combusted to generate heat and steam. The heat calcines the material to form treated material in the reaction chamber 212. Steam is also generated in the reaction chamber by the dehydration (i.e. calcination) of the material. Steam is also generated by the evaporation of surface moisture on the material in the drying section 224a. A majority of the material present in the reaction chamber is then treated to form the treated material in the reaction chamber. For example, if the material is a hydrate, the treated material is a dehydrated from of the hydrate.

The treated material along with any remaining clarified material is then transferred from the reaction chamber 212 to cyclone 242a where the remaining clarified material is calcined to form the treated material.

The majority, i.e. at least 80%, of the calcination of the clarified material generally occurs in the reaction chamber 212.

The steam that is generated in the reaction chamber 212 is transferred through the plant to baghouse 226. It is this transfer of steam from the reaction chamber 212 to the baghouse 226 that helps to at least partially transfer the material from material input 216 to cyclone 240. Upon exiting the baghouse 226 the steam is divided into the return steam line 220 and steam source 230.

After the material has been treated (i.e. formed) in the reaction chamber 212, it is then transferred to the heat recovery stage 228a. The heat recovery stage 228a has a number of cyclones 244 that clarify and cool the treated material. The treated material passes through the final cyclone 246 before passing through the treated material outflow 217. The return steam line 220 is in fluid communication with the final cyclone 246. The steam in the return steam line 220 fluidises and transports the treated material and material in the plant 200.

### EXAMPLES

### Example 1— Modelling Calcination Plant 200

The calcination plant 200 shown in FIG. 4 was modelled as an apparatus to calcine aluminium hydroxide, such as gibbsite, to form alumina using SysCAD to determine the flowrates of the various inputs and outputs used in the plant 200. In this example, aluminium hydroxide is the material (i.e. hydrate) and alumina is the treated material (e.g. dehydrated material).

In one example, 4.51 t/h of H₂ and 38.2 t/hg of O₂ is supplied to the reaction chamber 212 and 284 t/h of aluminium hydrate is fed into input 216.

The H₂ and O₂ combusted to generate 187 t/h of steam.

The value of 187 t/h of steam also includes steam generated in the reaction chamber 212 from dehydration of aluminium hydroxide.

Dehydration of aluminium hydroxide in the drying stage 224a and in the calcining stage 212a prior to the entry of aluminium hydroxide into the reaction chamber 212 means the total amount of steam being generated and transferred from the calcining stage 212a and the drying stage 224a to the baghouse 226 is 287 t/h.

The 284 t/h of aluminium hydrate forms 205 t/h alumina. 114 t/h of steam is transferred through the return steam line 220 to act as the transport gas for the particulate matter e.g. aluminium hydroxide and alumina.

A plant used to calcine aluminium hydroxide to form alumina using natural gas has an energy requirement of about 3 GJ/h, whereas the plant 200 has an energy requirement of about 2.9 GJ/h.

It is noted that the theoretical energy requirement to convert aluminium hydroxide to alumina in plant 200 is about 1.8-2.0 GJ/h, and the difference between the theoretical energy requirement and actual energy requirement is due to energy losses such thermal losses.

However, this calculation does not take into account the fact that the steam generated by the plant 200 can be used elsewhere to reduce the energy requirement of auxiliary equipment in an alumina refinery, so use of the plant 200 may help to improve the overall energy efficiency of an alumina refinery.

The Example is directed to calcination of aluminium hydroxide to form alumina, but the described apparatus and process are applicable to any material that can be dehydrated, calcined, subject to smelting, direct reduction processes including hydrogen reduction.

### Example 2—Simulating Steam Conditions (Similar to Those of Hydrogen-Oxygen Generated Steam) to Calcine Gibbsite (as the Source of Aluminium Hydroxide) into Alumina

The applicant operates natural gas-fired calciners to dehydrate aluminium hydroxide in the form of gibbsite (Al₂O₃.3H₂O) into alumina (Al₂O₃).

One difference between the current conditions in the applicant's natural gas-fired calciners and the invention is the use of a hydrogen-oxygen flame in accordance with the invention.

The properties of a hydrogen-oxygen flame include a combustion temperature that is significantly higher than the natural gas-air flame temperature (Table 1) and that hydrogen burns with a pale blue flame, leading to minimal heat transfer via radiation.

TABLE 1
Approximate flame temperatures

| | Combustion | Combustion |
|---|---|---|
| Fuel | with air (° C.) | with oxygen (° C.) |
| Natural gas | 1940 | 2760 |
| Hydrogen | 2130 | 2800 |

The dominant heat transfer mechanisms for a hydrogen-oxygen flame are convection and conduction via steam generated via combustion.

These heat transfer mechanisms allow for the hydrogen-oxygen flame to either be contained within the calcination apparatus or externally in a separate reaction chamber (as described above) whereby the steam and heat generated are then transferred to the calcination apparatus, allowing a vast majority of the solids in the calcination apparatus to reach the target temperature.

The risk of high temperature regions (associated with a hydrogen-oxygen flame) in the calcination apparatus is at least substantially eliminated with a separate hydrogen combustion chamber.

Notwithstanding the comments in the preceding paragraph, it is noted that both options of containment of a hydrogen-oxygen flame within the calcination apparatus or externally in a separate reaction chamber are viable options.

Another difference between the current conditions in the applicant's natural gas-fired calciners and the invention is the gas composition in the calcination apparatus. If oxygen is combusted with hydrogen, the calciner flue gas would be pure steam, and if oxygen-enriched air is used the flue gas would be a combination of nitrogen and steam.

Some studies have shown the thermal decomposition rate of gibbsite with respect to water vapor concentration was negative, meaning that the water vapor that is produced impedes further gibbsite calcination, whilst there is a counter-view that high water vapor pathways may progress unimpeded via the Boehmite, Gamma, Delta, Theta and ultimately Alpha pathways.

Industrially, gibbsite calcination is conducted in flash calciners and in bubbling or circulating fluidised beds (CFB) reactors.

CFB technology can be scaled up without consequences for product quality, owing to the recirculation of solids in the CFB which results in an even temperature distribution and homogenous product quality also at large capacities and during load changes.

The main components of a CFB calcination process are two preheating stages, a calcining stage and two cooling stages. The entire residence time from when the feed material is fed into the process to the point when the alumina product is discharged is typically approximately 20 minutes. CFB calciners typically operate in a range from 900 to 1000° C., depending on product quality targets. The material is held at the target temperature for 6 minutes.

A primary reason for this Example was to simulate steam conditions (similar to those of hydrogen-oxygen generated steam) in order to calcine gibbsite into alumina, under conditions replicating a typical Circulating Fluid Bed Calciner.

The test work was conducted in a laboratory scale Circulating Fluid Bed reactor.

Test Work Methodology

An 85 mm diameter CFB reactor with external electric furnace was used to test calcination of gibbsite in a steam environment.

Prior to each test, the gibbsite was dried at 105° C. to remove any free moisture. The dried solids were then placed in a pressure feeder.

The furnace was heated to target temperature. Low flows of nitrogen were introduced into the system at the following points:
Pressure feeder.
Recirculation line loop seal.
Sample point at bottom of furnace.

These nitrogen flows were required to prevent steam condensing in cooler parts of the system and causing blockages.

The steam was then introduced at the target flow rate, and once the temperature inside the reactor had stabilised, ˜1.5 kg of solids were introduced into the system via the pressure feeder.

Once the solids had reached the target temperature they were held in the system for the required duration prior to sampling the solids in the collection flask at the bottom of the furnace.

Nitrogen was introduced into the flask to help cool the solids in an inert atmosphere and also to displace the steam from the solids before water condensed in the collection flask.

### Results

To simulate hydrogen combustion with oxygen in applicant's calciners, the following test condition were used:

TABLE 2
Summary of test work conditions

| | Gas flowrates | Gas flowrates | Residence |
|---|---|---|---|
| Temperature | (1/min) | (1/min) | time |
| (° C.) | Steam | N₂ | (min) |
| 950 | 25 | 30 | 30 |

Due to the small scale of the equipment and high ambient heat losses, steam condensation occurred in the discharge alumina port, leading to alumina blockages during the test work. For this reason, nitrogen was introduced in increasing amounts as an inert gas to keep the steam from condensing and causing material blockages.

Once the material blockages were resolved with inert gas flow, the gibbsite was calcined with the following outcomes:

X-Ray Diffraction (XRD)

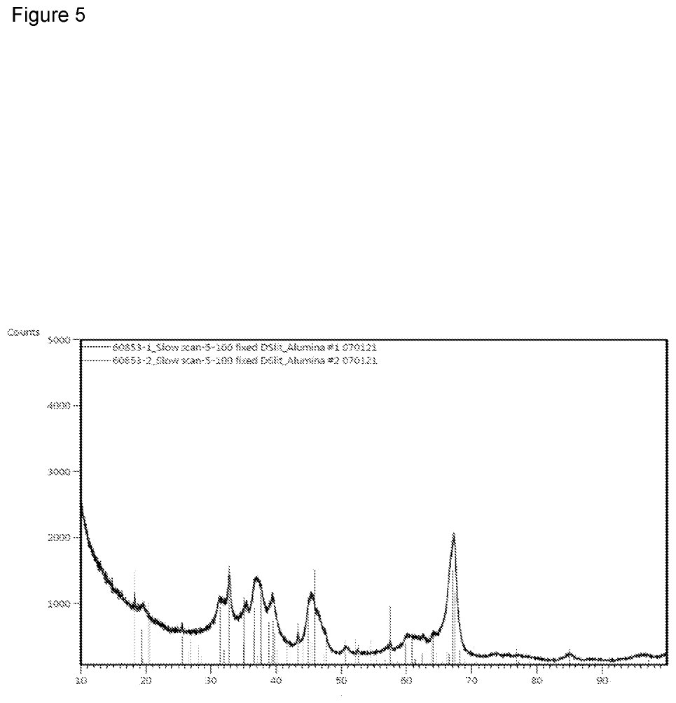

XRD was used to identify the alumina phases formed during the calcination process. Characteristic pattern for the two submitted samples is shown in FIG. 5.

From FIG. 5 it is possible to see the following:

1. Gibbsite was calcined predominantly into gamma and theta alumina phases—this is consistent with the applicant's Smelter Grade Alumina product quality specifications.

2. Gibbsite was marginally calcined into the alpha alumina phase in trace amounts—this is consistent with applicant's Smelter Grade Alumina product quality specifications

Loss on Ignition (LOI)

Loss on ignition was used to determine the amount of gibbsite converted into the alumina phases described above. From this it was possible to see that:

1. Alumina surface moisture was negligible, with a <0.05% remaining water content.

2. Gibbsite conversion to alumina was ˜99.7% complete—this is consistent with applicant's Smelter Grade Alumina product quality specifications.

### DISCUSSION

The above results indicate that steam under the conditions produced by a hydrogen-oxygen flame makes it possible to calcine gibbsite into alumina.

Furthermore, the results indicate that the alumina produced is suitable to meet the applicant's Smelter Grade Alumina specification.

Additionally, the formation of major quantities of gamma and theta alumina, support the calcination pathway expected under high vapour conditions:

Gibbsite (Boehmite)→Gamma Alumina→(Delta Alumina)→Theta Alumina→Alpha Alumina

While the phases in brackets were not directly observed, the technical literature indicates that these phases may have been present during the decomposition reactions.

The above-described use of nitrogen in the test work to manage material handling issues was required due to the small laboratory scale nature of the equipment allowing steam to condense on surfaces exposed to the atmosphere. This is not expected to be an issue on scale-up.

The above test work to calcine gibbsite into alumina indicates to the inventors that hydrogen can be used as a combustion fuel in place of natural gas for calcination processes, such as calcination of aluminium hydroxide to form alumina and dehydration of gypsum to form anhydrite, and for reductive processes.

Many modifications may be made to the embodiments of the present invention described above without departing from the spirit and scope of the invention.

1. A process for treating a material comprising: reacting hydrogen and oxygen in a reaction chamber and producing heat and steam, discharging the steam from the reaction chamber, using the heat to treat the material and produce a treated material, and returning at least some of the steam discharged from the reaction chamber to the process.

2. The process defined in claim 1 comprises producing the steam by reacting the hydrogen and oxygen via combustion of hydrogen and oxygen gas.

3. The process defined in claim 1 comprises producing the steam by reacting the hydrogen and oxygen via hydrogen reacting with chemically-bound oxygen.

4. The process defined in claim 1 comprising producing the steam in the reaction chamber when forming the treated material.

5. The process defined in claim 1 comprising maintaining the steam at a temperature that is above a condensation temperature of steam.

6. The process defined in claim 1 comprising using the steam produced in the reaction chamber as a transport gas in the process.

7. The process defined in claim 1 comprising using the steam produced in the reaction chamber as a heat transfer medium in the process.

8. The process defined in claim 1 wherein, after the process has reached a predetermined condition, the process includes discharging a flue gas from the reaction chamber that is at least 95% by volume steam.

9-10. (canceled)

11. The process defined in claim 1 including transferring at least some of the steam produced in and discharged from the process to a mechanical vapor re-compressor, a thermal vapor re-compressor, a power generator and/or a heat recovery unit.

12. (canceled)

13. The process defined in claim 1 wherein the material is a hydrate and the treated material is a dehydrated form of the hydrate.

14. The process defined in claim 1 wherein the material is a metal oxide and the treated material is a reduced form of the metal oxide.

15. The process defined in claim 1 being a calcination process to dehydrate a material.

16. (canceled)

17. A process for treating a material comprising: combusting hydrogen and oxygen and generating steam and heat, using the heat to treat the material and produce a treated material, and using the steam generated from said combustion as a transport gas in the process.

18. The process defined in claim 17 further including discharging the steam from the process and then transferring at least some of the discharged steam to the process.

19. The process defined in claim 17 including combusting the hydrogen and oxygen and generating the steam and heat in the reaction chamber and treating the material in the reaction chamber.

20. The process defined in claim 17 including combusting the hydrogen and oxygen and generating the steam and heat in one reaction chamber and transferring the steam and heat to a second reaction chamber and treating the material in the second reaction chamber.

21. (canceled)

22. An apparatus for treating a material, the apparatus comprising:
a reaction chamber configured to treat the material;
a source of hydrogen that can react with oxygen in the reaction chamber for treating the material in the reaction chamber and producing a treated material and a flue gas including steam;
an outlet for the treated material;
an outlet for the flue gas; and
a first line for supplying at least a portion of flue gas discharged via the flue gas outlet to the apparatus.

23. (canceled)

24. The apparatus defined in claim 22 including a first reaction chamber for treating the material and a second reaction chamber for combusting the hydrogen and oxygen and generating heat for use in the first reaction chamber.

25. (canceled)

26. A process of starting up a plant for treating a material, the plant comprising a reaction chamber in which the material is treated, the process comprising: a preheating step of heating the reaction chamber until predetermined conditions are achieved; and then commencing supply of the material to the reaction chamber.

27. (canceled)

28. The process defined in 26 wherein the preheating step includes combusting hydrogen in the reaction chamber and generating heat.
